(19) United States
(12) Patent Application Publication
(10) Pub. No.: US 2016/0364905 A1
(43) Pub. Date: Dec. 15, 2016

(54) APPARATUS AND METHOD FOR GENERATING 3D MODEL

(71) Applicant: ELECTRONICS AND TELECOMMUNICATIONS RESEARCH INSTITUTE, Daejeon (KR)

(72) Inventors: Soon-Chul JUNG, Daejeon (KR); Hyun KANG, Daejeon (KR); Jae-Hean KIM, Sejong (KR); Young-Mi CHA, Daejeon (KR); Jin-Sung CHOI, Daejeon (KR)

(21) Appl. No.: 15/045,594

(22) Filed: Feb. 17, 2016

(30) Foreign Application Priority Data
Jun. 15, 2015 (KR) 10-2015-0084302

(51) Int. Cl. G06T 17/10

(52) U.S. Cl. CPC G06T 17/10; G06T 2207/10028; G06T 2200/08; G06T 2200/04; G06T 2207/30204; G06T 2215/16; G06T 2219/2004

(57) ABSTRACT

An apparatus and method for generating a 3D model, in which point clouds from a scanner are automatically aligned using marker information, with markers attached to an object. The apparatus includes a point cloud refinement unit for receiving point clouds and marker sets from scanning of an object, refining the point clouds, and transmitting refined point clouds and marker sets, a point cloud alignment unit for inquiring of a point cloud and marker set database about a point cloud group of point cloud pairs and a marker set group of marker set pairs, and aligning the point cloud group, wherein the point cloud pairs and the marker set pairs are acquired by scanning a single object in different directions, and a surface generation unit for generating a 3D model by reconstructing a surface of the object based on the aligned point cloud group.

### CROSS REFERENCE TO RELATED APPLICATION

This application claims the benefit of Korean Patent Application No. 10-2015-0084302, filed Jun. 15, 2015, which is hereby incorporated by reference in its entirety into this application.

### BACKGROUND OF THE INVENTION

1. Technical Field

The present invention generally relates to an apparatus and method for generating a three-dimensional (3D) model, and more particularly, to an apparatus and method whereby markers are attached to a target object, and a high-precision 3D surface model is generated from point clouds acquired from a handheld scanner that scans the target object.

2. Description of the Related Art

An object of a 3D scanner is to generate point clouds of geometric samples on the surface of an object.

Of various 3D scanners, a triangulation-based laser 3D scanner has been widely used, owing to the relatively low cost thereof. Such a triangulation-based laser 3D scanner emits a laser point from a laser emitter to an object. Here, the laser point is found by checking an image taken by a camera. The laser point appears at different locations in the camera image depending on the distance at which laser light hits the surface of the object. Here, the core idea of triangulation is to detect the location of the laser point by determining the shape and size of a triangle formed by the laser point, the camera, and the laser emitter.

Since the coordinates of the points obtained from a single image in this way are represented by a unique coordinate system of the corresponding image, coordinate systems of the points in multiple consecutive images, obtained when scanning, must be transformed into a single reference coordinate system. Here, a transformation matrix for transforming the coordinate systems into a common reference coordinate system may be obtained if unique feature points are detected from the images and the same feature point is found in two consecutive images.

As a method of obtaining feature points from an image, there is a method of obtaining feature points based on the characteristics of neighboring pixels in an image, such as the colors and gradient magnitudes thereof. As another method, there is a method of attaching silver-colored and sticker-type circular markers, having high reflexibility, to the floor of space or to the object itself and detecting the markers as feature points in the image. Since each marker in the image may be easily distinguished from the others due to the characteristics thereof, it may function more reliably as a feature point than the above method.

Since it is difficult for the scanner to obtain a complete model that covers the left/right, front/rear, and upper/lower portions of an object via only a single scan in most cases, a scan must be performed several times in different directions. In some cases, even the object itself must be moved for a scan. Since point clouds acquired from respective scans in this way are individually set using their own coordinate systems, an alignment procedure for transforming respective coordinate systems into a common reference coordinate system in a way similar to the above-described scheme must be undertaken. At this time, a point cloud obtained in each scan must partially overlap a point cloud obtained in at least one additional scan so as to realize alignment.

The most typical method of aligning point clouds is to perform an Iterative Closest Point (ICP) algorithm. Such an ICP algorithm works normally only when point clouds are approximately aligned in the initial stage.

As a method of providing an initial solution to the ICP algorithm, there are methods such as a method using feature points in point clouds and a user interaction method.

The method using feature points is intended to obtain feature points having special attributes compared to those of surrounding portions, for example, pointed portions or edges, from point clouds and detect the same feature points from two point clouds. However, point clouds obtained by scanning a flat object or an object having a uniform curvature have feature points, the attributes of which are very similar to each other, and thus the results of detection are not desirable.

Therefore, specialized commercial scanner software (SW), such as Artec Studio, or inexpensive software (SW) attached to a David scanner provides a user interaction method that allows a user to map the same area while directly viewing two point clouds, thus realizing initial alignment. Such a user interaction method may obtain the best initial alignment results via a human being's intervention, but a very long time is required for a mapping task when several tens of scans are performed. That is, from the standpoint of automation, the interaction itself may be regarded as a disadvantage.

As preceding technologies related to the present invention, there are Korean Patent Application Publication No. 2004-0010091 (entitled “Apparatus and Method for Registering Multiple Three Dimensional Scan Data by using Optical Marker”) and U.S. Patent Application Publication No. 2008-0201101 (entitled “Auto-Referenced System and Apparatus for Three-Dimensional Scanning”).

Accordingly, an alignment method, which can be automatically performed while exhibiting effects similar to those of the user interaction method, is required.

### SUMMARY OF THE INVENTION

Accordingly, the present invention has been made keeping in mind the above problems occurring in the prior art, and an object of the present invention is to provide an apparatus and method for generating a 3D model, in which point clouds obtained from a scanner are automatically aligned using marker information, with markers attached to an object.

In accordance with an aspect of the present invention to accomplish the above object, there is provided an apparatus for generating a three-dimensional (3D) model, including a point cloud refinement unit for receiving point clouds and marker sets from scanning of an object, refining the point clouds, and transmitting refined point clouds and the marker sets to a point cloud and marker set database; a point cloud alignment unit for inquiring of the point cloud and marker set database about a point cloud group composed of pairs of point clouds and a marker set group composed of pairs of marker sets, and aligning the point cloud group, wherein the point cloud pairs and the marker set pairs are acquired by scanning a single object in different directions; and a surface generation unit for generating a 3D model by performing surface reconstruction based on the aligned point cloud group.

The point cloud refinement unit may be configured to, when an average of distances from each point in a given point cloud to a predetermined number of neighboring points is equal to or greater than a predetermined value, determine the corresponding point to be an outlier, and automatically remove the outlier.

The point cloud refinement unit may be configured to, when an outlier that is not automatically removed is present, remove the outlier under selection of a user.

The point cloud alignment unit may align the point cloud group using the marker set group.

The point cloud alignment unit may align the point cloud group using a transformation matrix that is used when coordinate systems of other marker sets in the marker set group are transformed into a coordinate system of a first marker set in the marker set group.

The surface generation unit may perform surface reconstruction using an algorithm for generating a 3D polygonal mesh model.

Each point cloud may be a set of acquired points, and each point may have a unique 3D location.

Each marker set may be a set of 3D locations of acquired markers.

In accordance with another aspect of the present invention to accomplish the above object, there is provided a method for generating a three-dimensional (3D) model, including receiving, by a point cloud refinement unit, point clouds and marker sets from scanning of an object, and refining the point clouds; transmitting, by the point cloud refinement unit, refined point clouds and the marker sets to a point cloud and marker set database, inquiring of, by a point cloud alignment unit, the point cloud and marker set database about a point cloud group composed of pairs of point clouds and a marker set group composed of pairs of marker sets, wherein the point cloud pairs and the marker set pairs are acquired by scanning a single object in different directions; aligning, by the point cloud alignment unit, the point cloud group; and generating, by a surface generation unit, a 3D model by performing surface reconstruction based on the aligned point cloud group.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of an overall system employing an apparatus for generating a 3D model according to an embodiment of the present invention;

FIG. 2 is a diagram showing the configuration of an apparatus for generating a 3D model according to an embodiment of the present invention;

FIG. 3 is a diagram illustrating a scan target object to which markers are attached;

FIG. 4 is a flowchart showing a method performed by the 3D model generation apparatus according to an embodiment of the present invention;

FIGS. 5 and 6 are diagrams showing examples of a point cloud and a marker set employed in the description of FIGS. 4; and

FIG. 7 is a diagram showing a computer system in which the embodiment of the present invention is implemented.

### DESCRIPTION OF THE PREFERRED EMBODIMENTS

The present invention may be variously changed and may have various embodiments, and specific embodiments will be described in detail below with reference to the attached drawings.

However, it should be understood that those embodiments are not intended to limit the present invention to specific disclosure forms and they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings and repeated descriptions of the same components will be omitted.

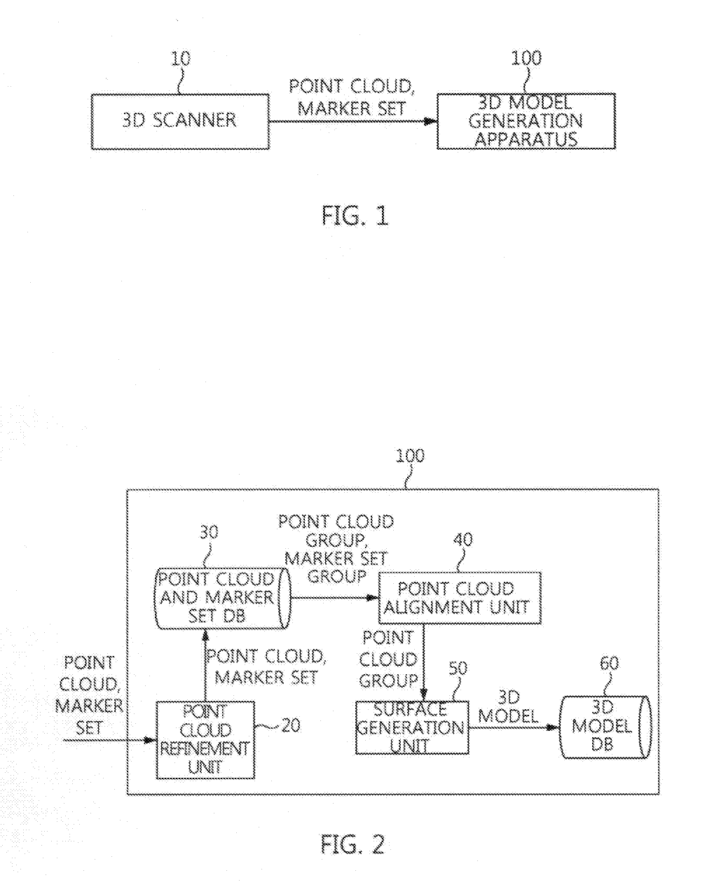

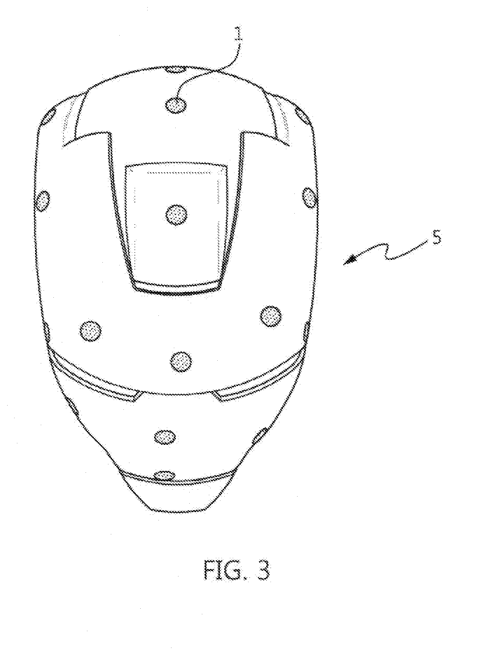

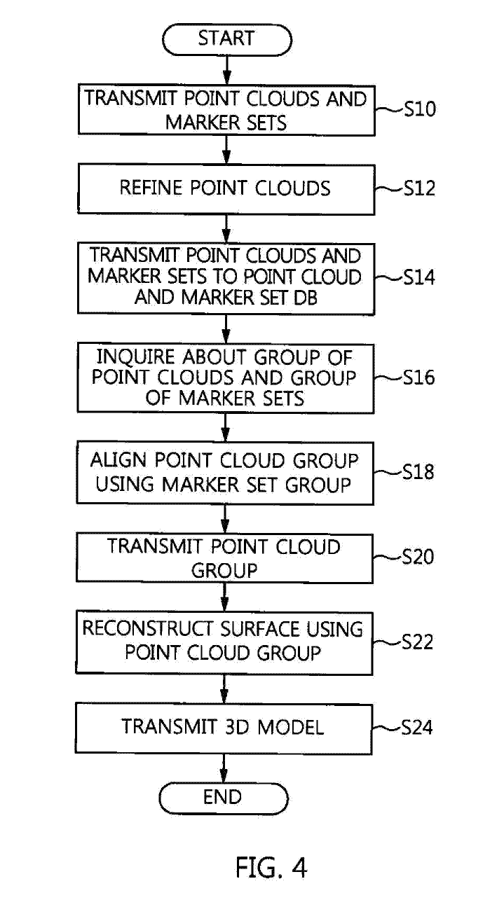

FIG. 1 is a diagram showing the configuration of an overall system employing an apparatus for generating a 3D model according to an embodiment of the present invention, FIG. 2 is a diagram showing the configuration of an apparatus for generating a 3D model according to an embodiment of the present invention, and FIG. 3 is a diagram illustrating a scan target object to which markers are attached.

An apparatus 100 for generating a 3D model according to an embodiment of the present invention receives point clouds and marker sets from a 3D scanner 10 and generates a 3D polygonal model.

In FIG. 1, the 3D scanner 10 scans an object 5 to which one or more markers 1 are attached, as shown in FIG. 3, and then generates point clouds and marker sets.

The 3D model generation apparatus 100 according to the embodiment of the present invention includes a point cloud refinement unit 20, a point cloud and marker set database (DB) 30, a point cloud alignment unit 40, a surface generation unit 50, and a 3D model DB 60.

The point cloud refinement unit 20 receives the point clouds and the marker sets from the 3D scanner 10 and removes outliers from each point cloud. Here, the outliers in the point cloud may be regarded as points having an abnormal distribution in the corresponding point cloud. The point cloud refinement unit 20 transmits pairs of refined point clouds and pairs of marker sets to the point cloud and marker set DB 30.

The point cloud and marker set DB 30 stores multiple pairs of point clouds and multiple pairs of marker sets, obtained by scanning a single object in different directions.

The point cloud alignment unit 40 loads a group of point cloud pairs and a group of marker set pairs related to a single object from the point cloud and marker set DB 30, aligns other point clouds with the coordinate system of a reference point cloud, and transmits the aligned point clouds to the surface generation unit 50.

The surface generation unit 50 integrates a group of point clouds into a single point cloud, and generates (reconstructs) a surface as a polygonal mesh based on the integrated point cloud. In an embodiment of the present invention, the surface generated as a polygonal mesh is referred to as a “3D model” (also referred to as a “3D polygonal model”).

The 3D model DB 60 stores the 3D model generated by the surface generation unit 50.

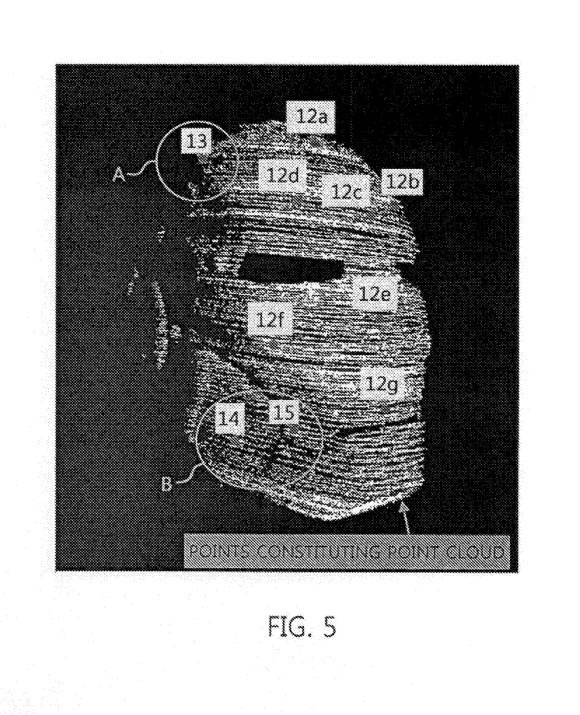

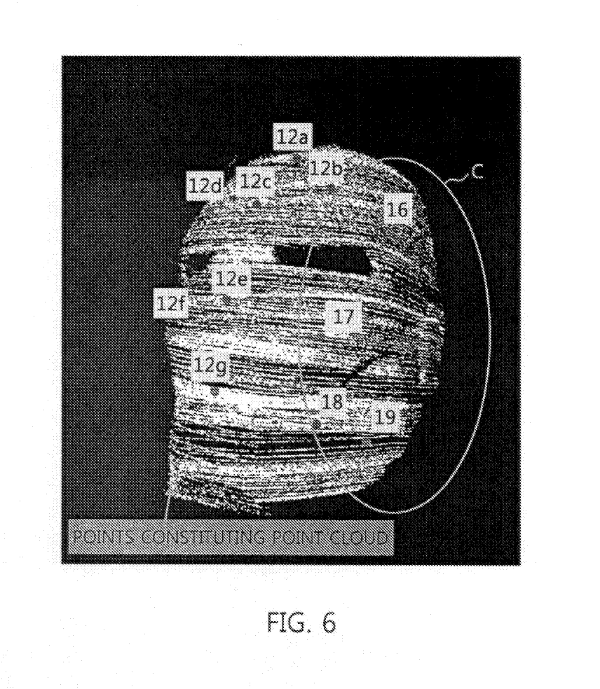

FIG. 4 is a flowchart showing a method performed by the 3D model generation apparatus according to an embodiment of the present invention, and FIGS. 5 and 6 are diagrams showing examples of a point cloud and a marker set employed in the description of FIG. 4.

First, once a single scan of an object is terminated, the 3D scanner 10 transmits point clouds and marker sets acquired up to that time to the point cloud refinement unit 20 at step S10. Here, the term “point cloud” denotes a set of acquired points, each point having its own 3D location represented by at least (x, y, z). Additionally, the point cloud may have attributes, such as color and a direction vector from each point to a sensor at the time of capturing the point. The term “marker set” denotes a set of 3D locations of acquired markers. Here, both the 3D location of a point and the 3D location of a marker are defined in a common reference coordinate system. In FIGS. 5 and 6, examples of a point cloud and a marker set in two scan operations are illustrated. Portions seen as white lines actually indicate points constituting respective point clouds, and the points appear as lines because they are densely gathered. Large gray points indicate markers. FIG. 5 illustrates point clouds and marker sets obtained by scanning a mask while viewing the right side of the mask. In FIG. 5, markers 13, 14, and 15 in circles A and B will not be viewed via a scan on the other side. FIG. 6 illustrates point clouds and marker sets obtained by scanning a mask while viewing the left side of the mask. In FIG. 6, markers 16, 17, 18, and 19 in circle C will not be viewed via a scan on the other side. The remaining markers (e.g. 12a, 12b, 12c, 12d, 12e, 12f, and 12g) are markers viewed even via the scan on the other side. There may occur the case where two scans do not completely overlap each other. In this case, markers viewed even via the scan on the other side, such as points 12a, . . . , 12g, are not present

Then, the point cloud refinement unit 20 removes outliers, which are not actually present on the surface of the object, from the received point clouds at step S12. In this case, as the method of removing outliers, both the method of automatically removing the outliers and the method of manually removing the outliers may be used A typical automatic removal method is performed by obtaining the average of distances from each point to a predetermined number of neighboring points, determining the corresponding point to be an outlier if the average is equal to or greater than a predetermined value, and removing the outlier. An outlier which cannot be removed using the automatic removal method may be removed in such a way that the user personally selects the outlier.

The point cloud refinement unit 20 transmits pairs of point clouds refined in this way and pairs of marker sets to the point cloud and marker set DB 30 and stores the pairs in the point cloud and marker set DB 30 at step S14.

In order to sufficiently and desirably reconstruct the surface of the object, the procedure for scanning the object in different directions, and refining and storing the scanned results (i.e. steps S10 to S14) is repeated.

After the object scanning in different directions, and the refining and storage of the scanned results have been completed, the point cloud alignment unit 40 inquires of the point cloud and marker set DB 30 about a group composed of pairs of point clouds and a group of composed of pairs of marker sets, which are acquired by scanning a single object in different directions, at step S16. Those point clouds currently have their own separate coordinate systems.

Thereafter, the point cloud alignment unit 40 automatically aligns a currently given point cloud group using the marker set group at step S18. That is, when the marker set group is aligned, the point cloud group may be aligned. Here, the alignment aims at conforming different coordinate systems of the point cloud group to a single common coordinate system. Generally, the coordinate systems of other point clouds in the point cloud group may be transformed into the coordinate system of the first point cloud thereof. In some scans, point clouds and marker sets have the same coordinate system. Therefore, the coordinate systems of the point clouds may be conformed to each other using a transformation matrix, which is used when the coordinate systems of other marker sets are transformed into the coordinate system of a first marker set. This procedure will be described in detail later.

Thereafter, the point cloud alignment unit 40 transmits the aligned point cloud group to the surface generation unit 50 at step S20.

The surface generation unit 50 performs surface reconstruction using the received point cloud group at step S22. Then, since the point cloud group has been aligned, the point cloud group may be simply regarded as a single point cloud.

The surface generation unit 50 generates a 3D model (i.e. 3D polygonal model) via surface reconstruction. In this regard, an algorithm for generating a 3D polygonal mesh model from point clouds generated by sampling the surface of an object is widely known. For example, a Poisson surface reconstruction algorithm, proposed by M. Kazhdan, et al., may be a representative thereof.

The surface generation unit 50 transmits the newly generated 3D model to the 3D model DB 60 at step S24.

In this way, the 3D model generation procedure is completed by transmitting the generated 3D model to the 3D model DB 60.

Below, the operation at step S18 will be described in detail. At step S18, it has been stated that the coordinate systems of point clouds may be conformed to each other using the transformation matrix, which is used when the coordinate systems of other marker sets are transformed into the coordinate system of the first marker set. Here, the transformation matrix may be detected using an algorithm for conforming the coordinate systems of marker sets to each other.

For example, when any marker set is given, the respective markers of the corresponding marker set may be regarded as corresponding to vertices. Therefore, a complete graph, in which edges are present between all vertices, may be produced Since the markers (vertices) are located in 3D space, length attributes may be assigned to the edges of the graph. Further, as illustrated in FIGS. 5 and 6, since point clouds corresponding to marker sets are present, curvature attributes may be easily calculated using neighboring points of each marker, and may be assigned as features to the markers (vertices). Meanwhile, when the point clouds have color attributes, the color attributes may also be combined with other attributes as the features of markers (vertices).

Further, in order to transform the coordinates system of a marker set S (source) into the coordinate system of a reference marker set T (target), three or more identical markers which are shared between the marker set S and the reference marker set T must be detected. The problem of detecting all identical markers seems to be similar to the problem of detecting maximum common sub-graphs from two graphs (maximum common sub-graph isomorphism problem). However, in this problem, the identical markers may be detected much faster using the above-described attributes. Furthermore, the transformation matrix may be obtained even if only three or four identical markers are detected, without the need to detect all identical markers. Assuming that one marker s_i in the marker set S is physically identical to the marker t_j in the reference marker set T, the two markers must have the same features. Further, the two marker sets must have a number of edges having the same length, which corresponds to “the number of identical markers-l”, and the end vertices of the corresponding edge must be the members of the same marker set.

Therefore, an algorithm for conforming the coordinate system of a given marker set group {M_1, . . . , M_n} to the coordinate system of a first marker set (e.g. M_1) is performed in the following sequence.

1) For each marker set M_i, initialization is performed as transformed (M_i)=0 and checked (M_i)=0.

2) For each marker set M _i, a complete graph is configured. Here, for vertices, features (curvatures, or combinations of curvatures and colors) are obtained and the vertices are arranged in the sequence of the features for high efficiency. Meanwhile, the edges attached to the vertices are also arranged in the sequence of length.

3) For the first marker set M_1, transformed (M_1)=1 is set. This indicates that the coordinate system of the first marker set has already been transformed.

4) This step is repeated until there are no more marker sets having a ‘transformed’ state of 1 and a ‘checked’ state of 0.

4-1) Marker set M, having a ‘transformed’ state of 1 and a ‘checked’ state of 0, is considered.

4-2) In the marker set, checked (M_i)=1 is set (it means that the corresponding marker set is being checked).

4-3) For each marker set M_j having a ‘transformed’ state of ‘0’, an attempt is made to transform the M_j coordinate system into the M_i coordinate system. When the M_j coordinate system is transformed into the M_i coordinate system, transformed (M_j)=1 is set. If no identical markers are present between the marker set M_i and the marker set M_j, and thus coordinate systems are not transformed, transformed (M_j) still has a value of ‘0’.

Meanwhile, in the above procedure, the M_j coordinate system may be regarded as the coordinate system of the marker set S (source), and the M_i coordinate system may be regarded as the coordinate system of the reference marker set T (target). Here, the algorithm for transforming the coordinate system of the marker set S into the coordinate system of the reference marker set T, performed at step 4-3), is performed in the following sequence.

1) A group of identical marker candidate pairs C={(s_i, t_i)|s_i is the marker of S, t_i is the marker of T, and s_i and t_i have the same features and have a predetermined number (typically 2 to 3) or more of edges having the same length as a result of comparing the numbers of edges connected to s_i and t_i with each other) is obtained. Since the vertices and edges have already been aligned, the time required to calculate C varies linearly with the number of vertices.

2) Group C is refined via the following steps 2-1) and 2-2).

2-1) For each of the members (s, t) of group C, when the corresponding member remains in group C only when a vertex at the other end of each edge of the member belongs to the vertices of the member belonging to group C, if the number of edges having the same length decreases below a predetermined number, the corresponding member is removed from group C.

2-2) If a member has ever been removed from group C, step 2) is performed again.

3) If the size of group C is less than or equal to a predetermined value, this means that a meaningful number of identical markers is not present, and thus the algorithm is terminated without transformation.

4) For each of members (s_i, t_i) belonging to group C, the following steps 4-1) to 4-3) are performed.

4-1) Group V of identical marker pairs is initialized to V={(s_i, t_i)}.

4-2) When another (s_j, t_j) belonging to group C has a neighboring relation with all members belonging to group A, (s_j, t_j) is inserted into group V.

4-3) When the size of group V has reached a predetermined number (e.g. 3 to 4), a rigid transformation matrix from s_i to t_i may be obtained via well-known Singular Value Decomposition (SVD). By means of SVD, S and a point cloud corresponding to S are rigid-transformed. Further, in this state, for more precise alignment, an Iterative Closest Point (ICP) algorithm is applied. Then, the algorithm is terminated.

5) If a group of identical marker pairs having a predetermined size is not present, the algorithm is terminated without transformation.

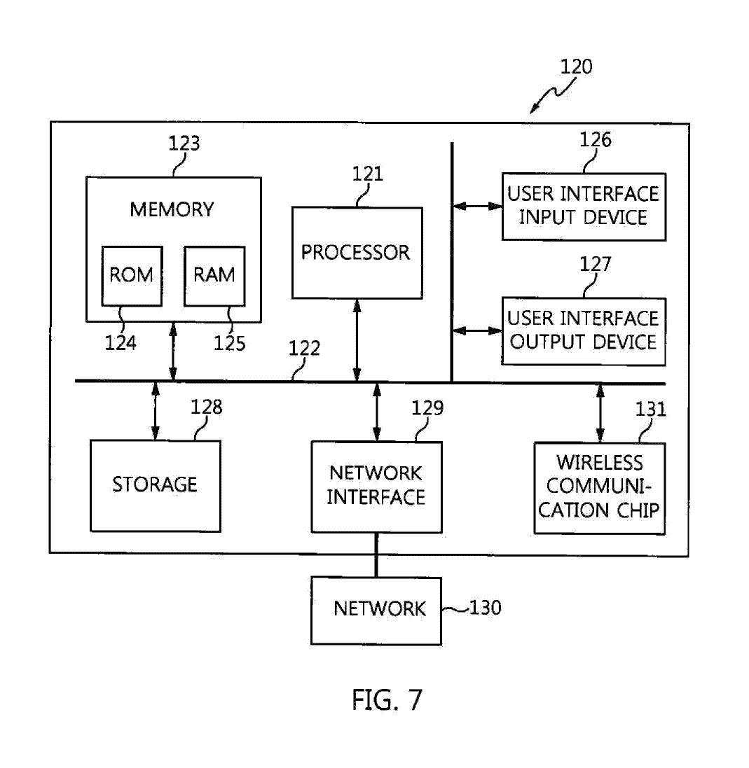

Meanwhile, the above-described embodiment of the present invention may be implemented in a computer system. As shown in FIG. 7, a computer system 120 may include one or more processors 121, memory 123, a user interface input device 126, a user interface output device 127, and storage 128, which communicate with each other through a bus 122. The computer system 120 may further include one or more network interfaces 129 connected to a network 130. Each processor 121 may be either a Central Processing Unit (CPU) or a semiconductor device for executing processing instructions stored in the memory 123 or the storage 128. Each of the memory 123 and the storage 128 may be any of various types of volatile or non-volatile storage media. For example, the memory 123 may include Read Only Memory (ROM) 124 or Random Access Memory (RAM) 125.

The computer system 120 may further include a wireless communication chip (WiFi chip) 131.

When computer-readable instructions are executed by a processor, the instructions may perform the method according to at least one embodiment of the present invention.

In accordance with the present invention having the above configuration, initial alignment is always automatically performed even on flat objects or objects having a uniform curvature (i.e. objects, the features of which are difficult to detect), thus enabling a high-precision 3D model to be generated.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. An apparatus for generating a three-dimensional (3D) model, comprising:
a point cloud refinement unit for receiving point clouds and marker sets from scanning of an object, refining the point clouds, and transmitting refined point clouds and the marker sets to a point cloud and marker set database;
a point cloud alignment unit for inquiring of the point cloud and marker set database about a point cloud group composed of pairs of point clouds and a marker set group composed of pairs of marker sets, and aligning the point cloud group, wherein the point cloud pairs and the marker set pairs are acquired by scanning a single object in different directions; and
a surface generation unit for generating a 3D model by performing surface reconstruction based on the aligned point cloud group.

2. The apparatus of claim 1, wherein the point cloud refinement unit is configured to, when an average of distances from each point in a given point cloud to a predetermined number of neighboring points is equal to or greater than a predetermined value, determine the corresponding point to be an outlier, and automatically remove the outlier.

3. The apparatus of claim 2, wherein the point cloud refinement unit is configured to, when an outlier that is not automatically removed is present, remove the outlier under selection of a user.

4. The apparatus of claim 1, wherein the point cloud alignment unit aligns the point cloud group using the marker set group.

5. The apparatus of claim 4, wherein the point cloud alignment unit aligns the point cloud group using a transformation matrix that is used when coordinate systems of other marker sets in the marker set group are transformed into a coordinate system of a first marker set in the marker set group.

6. The apparatus of claim 1, wherein the surface generation unit performs surface reconstruction using an algorithm for generating a 3D polygonal mesh model.

7. The apparatus of claim 1, wherein each point cloud is a set of acquired points, and each point has a unique 3D location.

8. The apparatus of claim 1, wherein each marker set is a set of 3D locations of acquired markers.

9. A method for generating a three-dimensional (3D) model, comprising:
receiving, by a point cloud refinement unit, point clouds and marker sets from scanning of an object, and refining the point clouds,
transmitting, by the point cloud refinement unit, refined point clouds and the marker sets to a point cloud and marker set database;
inquiring of, by a point cloud alignment unit, the point cloud and marker set database about a point cloud group composed of pairs of point clouds and a marker set group composed of pairs of marker sets, wherein the point cloud pairs and the marker set pairs are acquired by scanning a single object in different directions;
aligning, by the point cloud alignment unit, the point cloud group; and
generating, by a surface generation unit, a 3D model by performing surface reconstruction based on the aligned point cloud group.

10. The method of claim 9, wherein refining the point clouds comprises, when an average of distances from each point in a given point cloud to a predetermined number of neighboring points is equal to or greater than a predetermined value, determining the corresponding point to be an outlier, and automatically removing the outlier.

11. The method of claim 10, wherein refining the point clouds comprises, when an outlier that is not automatically removed is present, removing the outlier under selection of a user.

12. The method of claim 9, wherein aligning the point cloud group comprises aligning the point cloud group using the marker set group.

13. The method of claim 12, wherein aligning the point cloud group comprises aligning the point cloud group using a transformation matrix that is used when coordinate systems of other marker sets in the marker set group are transformed into a coordinate system of a first marker set in the marker set group.

14. The method of claim 9, wherein generating the 3D model comprises performing surface reconstruction using an algorithm for generating a 3D polygonal mesh model.

15. The method of claim 9, wherein each point cloud is a set of acquired points, and each point has a unique 3D location.

16. The method of claim wherein each marker set is a set of 3D locations of acquired markers.
